(19) United States
(12) Patent Application Publication
(10) Pub. No.: US 2025/0353599 A1
(43) Pub. Date: Nov. 20, 2025

(54) MICRO CHILLING - CLOSED LOOP HEATING / COOLING OF CUSHIONS FOR AIRCRAFT SEATING

(71) Applicant: B/E Aerospace, Inc., Winston-Salem, NC (US)

(72) Inventors: Noah Avram Meltz Weichselbaum, Prairie Village, KS (US); Christopher M. Wilson, Clemmons, NC (US); Christopher D. Adcock, Advance, NC (US); Brian E. St. Rock, Andover, CT (US); Matthew R. Pearson, Hartford, CT (US)

(21) Appl. No.: 19/213,347

(22) Filed: May 20, 2025

Related U.S. Application Data
(60) Provisional application No. 63/649,679, filed on May 20, 2024.

(51) Int. Cl. B64D 11/06

(52) U.S. Cl. CPC B64D 11/0626

(57) ABSTRACT

An aircraft seat includes a closed loop convective heat transfer system. The system utilizes a micro-chiller mounted directly to the seat frame. Integrated ducting through the seat diaphragm limits pressure drop and thermal duct wall losses. The system may be utilized in either a heating or cooling mode. Individual aircraft seats are individual addressable and controllable. The micro-chiller may be disposed on a rear surface of the aircraft seat for short ducting and high efficiency.

The present application claims the benefit under 35 U.S.C. § 119(e) of U.S. Provisional App. No. 63/649,679 (filed May 20, 2024), which is incorporated herein by reference.

### BACKGROUND

Heating and cooling of aircraft seating utilizes resistive heating stitched into a fabric liner for heating, and a pull-air system that uses small fans to pull air away from the passenger's body to create the sensation of cooling. Ducts for these fans are typically routed through a seat frame aluminum chassis that results in larger pressure drop. Coupled with a non-porous fire block, the pressure drop has a negative effect on performance.

These technologies were developed for the automotive industry. In the automotive industry, these pull systems benefit from vents in the dash being directed at the passenger to elevating the cooling effect. This technology is not effective in an aircraft cabin environment where elevated cabin temperatures result in warm air being pulled past the passenger, thereby limiting effectiveness.

### SUMMARY

In one aspect, embodiments of the inventive concepts disclosed herein are directed to an aircraft seat having a closed loop convective heat transfer system. The system utilizes a micro-chiller mounted directly to the seat frame. Integrated ducting through the seat diaphragm limits pressure drop and thermal duct wall losses.

In a further aspect, the system may be utilized in either a heating or cooling mode. Individual aircraft seats are individual addressable and controllable.

In a further aspect, the micro-chiller may be disposed on a rear surface of the aircraft seat for short ducting and high efficiency.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a perspective view of an aircraft seat according to an exemplary embodiment;

FIG. 2 shows a front view of an aircraft seat according to an exemplary embodiment;

FIG. 3 shows block diagrams of a system according to an exemplary embodiment;

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to an aircraft seat having a closed loop convective heat transfer system. The system utilizes a micro-chiller mounted directly to the seat frame. Integrated ducting through the seat diaphragm limits pressure drop and thermal duct wall losses. The system may be utilized in either a heating or cooling mode. Individual aircraft seats are individual addressable and controllable. The micro-chiller may be disposed on a rear surface of the aircraft seat for short ducting and high efficiency.

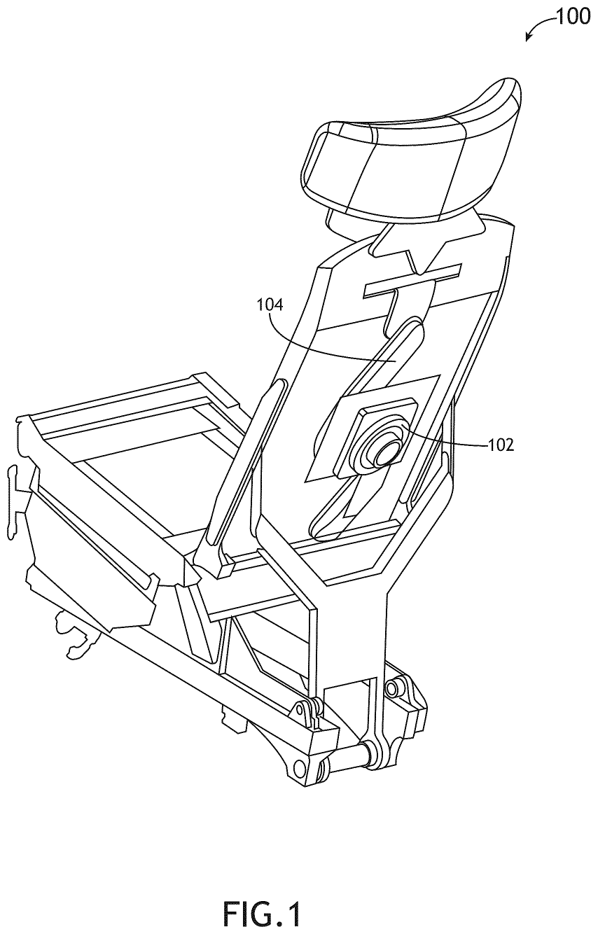

Referring to FIG. 1, a perspective view of an aircraft seat 100 according to an exemplary embodiment is shown. The aircraft seat 100 includes a micro-chiller 102 disposed on a posterior surface of the aircraft seat 100. In at least one embodiment, the micro-chiller 102 comprises a high efficiency air-to-air heat exchanger utilizing Peltier thermo-electrics as the cooling mechanism. Such mechanism is a sustainable solution with no refrigerant. A temperature differential is created across the thermal-electrics and, depending on the mode selected, the micro-chiller 102 either cools or heats the aircraft seat 100.

In at least one embodiment, ducting 104 may circulate air from the from the micro-chiller 102, around and within the aircraft seat back cushion. Because the micro-chiller 102 is disposed on the posterior of the aircraft seat 100, such ducting 104 may be minimized, resulting in a shorter path and higher overall thermal efficiency. Air may be ducted with a very short length for both inlet and outlet flows, directly through the seat diaphragm, limiting pressure drop. Additionally, ducting directly through the seat cushion foam, along with insulation applied to all external surfaces exposed to ambient conditions, enables a fully insulated flow path. Mounting with flexible flanges also enables the cooling system to have minimal deflections with the diaphragm; thereby preventing any open areas for leakage that would be an issue with a rigidly mounted system.

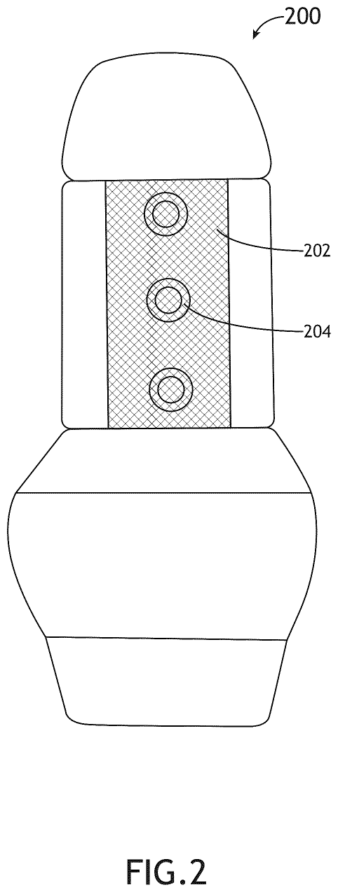

Referring to FIG. 2, a front view of an aircraft seat 200 according to an exemplary embodiment is shown. The aircraft seat 200 comprises a fabric/filler material 202 having a high open area ratio for fluid flow. The fabric/filler material 200 may include foam or some material with similar rigidity such that it feels like foam for passenger comfort. In at least one embodiment, the fabric/filler material may be encapsulated in a polyurethan bag to create a fully closed loop circulation path from an outlet to an inlet. For example, in a cooling mode, chilled air from the micro-chiller may circulate cooled air in the polyurethan bag to cool the passenger via conduction through the top layer of a cushion stack up.

In at least one embodiment, the aircraft seat 200 may include one or more support structures 204. Such support structures 204 reinforce the functionality of the seat back to support a passenger when the fabric/filler material 202 is generally porous to allow air flow.

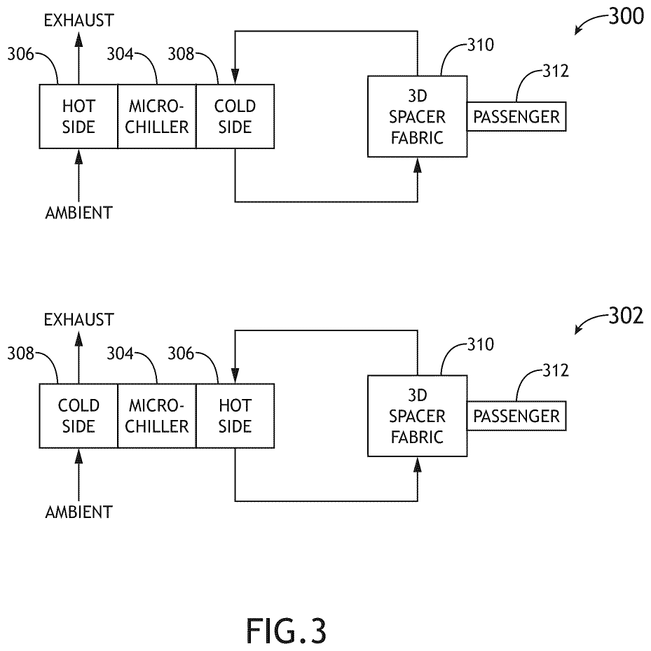

Referring to FIG. 3, block diagrams of a system 300, 302 according to an exemplary embodiment are shown. In one embodiment, the system 300 may operate in a cooling mode; alternatively, the system 302 may operate in a heating mode.

In at least one embodiment, the micro-chiller 304 may be operated in a cooling mode or heating mode based on current to the micro-chiller 304 (electrical polarity) where the micro-chiller 304 is thermal-electric. For example, when operated with a first current direction, the micro-chiller 304 may develop a cool side 308 proximal to the passenger 312 (or an aircraft seat including fabric/filler material 310 as described herein. The micro-chiller 304 also develops a hot side 306, distal from the passenger, that may be ventilated.

In at least one embodiment, the ventilated exhaust from the hot side 306 may be directed for some purpose. For example, the hot side exhaust may be directed toward a passenger's feet, or the footwell of a different passenger seated behind the aircraft seat (i.e., the footwell directly below the aircraft seat).

Likewise, when operated with a second current direction, the micro-chiller 304 may develop a hot side 306 proximal to the passenger 312 (or an aircraft seat including fabric/filler material 310 as described herein. The micro-chiller 304 also develops a cool side 308, distal from the passenger, that may be ventilated. The system 300, 302 may be switched from a cooling mode to a heating mode based on a passenger user interface.

In at least one embodiment, the ventilated exhaust from the cool side 308 may be directed for some purpose. For example, the cool side exhaust may be directed toward a passenger's feet, or the footwell directly below the aircraft seat. In either a heating mode or cooling mode, the exhaust may be sufficient to cool electronics, for example.

In either case, the system 300, 302 may operate with few moving parts (e.g., a fan to circulate air within the fabric/filler material 310) or no moving parts if conduction is sufficient.

In at least one embodiment, a processor configured via non-transitory processor executable code may applied stored profiles to produce heating and cooling over time. Such profiles may be specific to flight phases, dictated by ambient temperatures, specific to a passenger, etc.

Embodiments of the present disclosure may be incorporated into aircraft seats that translate from a taxi, takeoff, and landing position, to lounge, and to lay flat. The integrated design is compact and does not interfere with the mechanisms or brackets required for seat movement.

A surface temperature disparity of greater than 6° C. can be realized in a short time span. For cooling, this is greater than the desired surface temperature for passenger comfort, and can be easily be scaled back with a reduced power level to achieve a desired effect.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A seat temperature apparatus comprising:
a micro-chiller; and
at least one processor in data communication with the micro-chiller and a memory storing processor executable code for configuring the at least one processor to:
receive an input from a passenger; and
apply a signal to the micro-chiller based on the input,
wherein,
the micro-chiller is disposed on a posterior surface of a passenger seat.

2. The seat temperature apparatus of claim 1, further comprising a duct system connected to the micro-chiller configured to distribute air from the micro-chiller to an interior of the passenger seat, wherein the duct system defines an input and an output.

3. The seat temperature apparatus of claim 2, wherein:
the micro-chiller comprises a thermal-electric device; and
the at least one processor is configured to apply the signal to the micro-chiller in a first polarity such that the duct system output is proximal to a hot side of the micro-chiller.

4. The seat temperature apparatus of claim 3, wherein the at least one processor is configured to apply the signal to the micro-chiller in a second polarity such that the duct system output is proximal to a cool side of the micro-chiller.

5. The seat temperature apparatus of claim 3, wherein the at least one processor is configured to apply a variable voltage signal to the micro-chiller such that the micro-chiller develops an adjustable temperature disparity.

6. An aircraft seat comprising:
a micro-chiller;
a passenger input device; and
at least one processor in data communication with the micro-chiller and a memory storing processor executable code for configuring the at least one processor to:
receive an input from the passenger input device; and
apply a signal to the micro-chiller based on the input,
wherein,
the micro-chiller is disposed on a posterior surface of the aircraft seat.

7. The aircraft seat of claim 6, further comprising a duct system connected to the micro-chiller configured to distribute air from the micro-chiller to an interior of the aircraft seat, wherein the duct system defines an input and an output.

8. The aircraft seat of claim 7, wherein:
the micro-chiller comprises a thermal-electric device; and
the at least one processor is configured to apply the signal to the micro-chiller in a first polarity such that the duct system output is proximal to a hot side of the micro-chiller.

9. The aircraft seat of claim 8, wherein the at least one processor is configured to apply the signal to the micro-chiller in a second polarity such that the duct system output is proximal to a cool side of the micro-chiller.

10. The aircraft seat of claim 8, wherein the at least one processor is configured to apply a variable voltage signal to the micro-chiller such that the micro-chiller develops an adjustable temperature disparity.

11. The aircraft seat of claim 6, further comprising an air distribution element disposed in a seat back of the aircraft seat.

12. The aircraft seat of claim 11, wherein the air distribution element comprises a polyurethane bag defining an input and an output, and including a porous filler material.

13. A passenger comfort system comprising:
a micro-chiller disposed on a posterior surface of an aircraft seat;
a passenger input device; and
at least one processor in data communication with the micro-chiller and a memory storing processor executable code for configuring the at least one processor to:
receive an input from the passenger input device; and
apply a signal to the micro-chiller based on the input.

14. The passenger comfort system of claim 13, further comprising a duct system connected to the micro-chiller configured to distribute air from the micro-chiller to an interior of the aircraft seat, wherein the duct system defines an input and an output.

15. The passenger comfort system of claim 14, wherein:
the micro-chiller comprises a thermal-electric device; and
the at least one processor is configured to apply the signal to the micro-chiller in a first polarity such that the duct system output is proximal to a hot side of the micro-chiller.

16. The passenger comfort system of claim 15, wherein the at least one processor is configured to apply the signal to the micro-chiller in a second polarity such that the duct system output is proximal to a cool side of the micro-chiller.

17. The passenger comfort system of claim 15, wherein the at least one processor is configured to apply a variable voltage signal to the micro-chiller such that the micro-chiller develops an adjustable temperature disparity.

18. The passenger comfort system of claim 13, further comprising an air distribution element disposed in a seat back of the aircraft seat.

19. The passenger comfort system of claim 18, wherein the air distribution element is configured to distribute exhaust to cool an electronic element.

20. The passenger comfort system of claim 18, wherein the air distribution element is configured to distribute exhaust to a footwell.
